(19) United States
(12) Patent Application Publication
(10) Pub. No.: US 2006/0125723 A1
(43) Pub. Date: Jun. 15, 2006

(54) Plasma display apparatus and driving method thereof

(75) Inventors: Yoonchang Choi, Milyang-si (KR); Ki Duck Cho, Changwon-si (KR); Minsoo Kim, Gumi-si (KR); Won Jae Kim, Masan-si (KR)

Correspondence Address: BIRCH STEWART KOLASCH & BIRCH, PO BOX 747, FALLS CHURCH, VA, 22040-0747, US

(73) Assignee: LG Electronics, Inc.

(21) Appl. No.: 11/288,295

(22) Filed: Nov. 29, 2005

(30) Foreign Application Priority Data
Dec. 9, 2004 (JP) 10-2004-0103866

(51) Int. Cl. G09G 3/28

(52) U.S. Cl. 345/63

(57) ABSTRACT

There is provided a plasma display apparatus and a driving method thereof. The plasma display apparatus comprises an APL controller controlling an average picture level (APL) to adjust the number of setup waveforms depending on frame data inputted from the outside; a waveform generator generating a setup waveform depending on an average picture level; and a plasma display panel to which the setup waveform is applied, wherein the number of the setup waveform set in a reference section in which the average picture level increases is different from the number of the setup waveform set in the same section in which the average picture level decreases.

This Nonprovisional application claims priority under 35 U.S.C. §119(a) on Patent Application No. 10-2004-0103866 filed in Korea on Dec. 9, 2005, the entire contents of which are hereby incorporated by reference.

### BACKGROUND OF THE INVENTION

1. Field of the Invention

The present invention relates to a plasma display apparatus, and more particularly, to a plasma display apparatus and a driving method thereof.

2. Description of the Background Art

In general, when ultraviolet rays generated by gas discharge excite phosphors, a plasma display apparatus among display apparatuses displays an image using visible rays generated from the phosphors. The plasma display apparatus has an advantage in that it is thin in thickness and light in weight and can be made large with high definition, compared to a cathode ray tube (CRT) that has become the main stream of a display means so far.

In order to embody a gray level of an image, the plasma display apparatus is driven with one frame divided into several subfields having the different number of light emitting. Each subfield is divided into a reset period for uniformly generating discharge, an address period for selecting a discharge cell, and a sustain period for embodying a gray level depending on the number of discharge. For example, when an image is displayed with 256 gray levels, a frame period (16.67 ms) corresponding to 1/60 second is divided into 8 subfields. Each of 8 subfields is again sub-divided into an address period and a sustain period. The reset period and the address period of each subfield are equal in subfields. However, the sustain period and the number of discharge thereof increase in the ratio of 2ⁿ (n=0, 1, 2, 3, 4, 5, 6, 7) in each subfield in proportion to the number of sustain pulses. Because the sustain period is different in each subfield, a gray level of an image can be embodied.

Brightness of the plasma display apparatus is determined depending on the number of sustain pulses. Therefore, if the number of whole sustains becomes equal when average brightness is dark or bright, various problems such as deterioration in image quality, power consumption, and panel damage can be generated. Therefore, it is required to properly adjust the number of the whole sustain pulses depending on average brightness of the input image. For this reason, a convention plasma display apparatus comprises a circuit for controlling an average picture level (hereinafter, referred to as “APL”).

FIG. 1 is a diagram illustrating a method of embodying a waveform of a high contrast ratio by changing the number of setup waveforms of a reset period according to a conventional APL step.

As shown in FIG. 1, a conventional method of embodying a waveform of a high contrast ratio adjusts the number of setup waveforms in a reset period in which discharge is generated in an off cell depending on an APL step. For example, when there is a large amount of data to display on a screen, a black region is relatively small. Therefore, although the number of setup waveforms increases in a reset period, a contrast ratio is not largely deteriorated. In addition, many screen processing techniques are applied as an amount of data increases and thus the number of setup waveforms increases to stabilize driving. Otherwise, when there is a small amount of data to display on a screen, a black region increases. Therefore, in order to sustain a high contrast ratio, the number of setup waveforms in which discharge is generated even in the off cell is minimized.

In the figure, X is a step of a reference point in increase and decrease of the number of setup waveform among the APL steps. At this time, if the number of setup waveforms in X step is n, the number of setup waveforms in X+1 step can be expressed with the n+c number of setup waveforms larger by the c number of setup waveforms than the n number of setup waveforms, where n and c are natural numbers comprising 0.

FIG. 2 is a diagram illustrating another method of embodying a waveform of a high contrast ratio by changing the number of setup waveforms of a reset period according to a conventional APL step.

As shown in FIG. 2, another conventional method of embodying a waveform of a high contrast ratio adjusts the number of setup waveforms in a reset period depending on an APL step. At this time, setup waveforms having different peak voltages are applied. That is, the number of setup waveforms having a relatively low peak voltage is differently applied for each APL step and a setup waveform having a low peak voltage based on a specific APL step increases or decreases.

FIG. 3 is a diagram illustrating a method of applying to a plasma display apparatus by changing the number of setup waveforms or the number of setup waveforms having a low peak voltage according to a conventional APL step.

As shown in FIG. 3, the method of applying to a plasma display apparatus by changing the number of setup waveforms according to a conventional APL step changes the number of setup waveforms or the number of setup waveforms having a low peak voltage by setting an APL reference step (between X step and Y step). This is changed based on the same APL step regardless of an image in which APL gradually increases or decreases.

Specifically, when the number of setup waveforms applied to the APL reference step (between X step and Y step) is n, the n+c number of setup waveforms are applied in an APL step (Y) higher than the APL reference step (between X step and Y step) and the n−d number of setup waveforms are applied in an APL step (X) lower than the APL reference step (between X step and Y step), where n, c, and d are natural numbers comprising 0 and satisfy a relationship of n>d.

If the number of setup waveforms increases or decreases in the APL reference step or more or the APL reference step or less upon driving the plasma display apparatus, a waveform of a high contrast ratio can be embodied. However, there is a problem that flicker is generated if image data displayed on a screen within the APL reference step abruptly change.

### SUMMARY OF THE INVENTION

Accordingly, an object of the present invention is to solve at least the problems and disadvantages of the background art.

An object of the present invention is to provide a plasma display apparatus which can reduce a flicker phenomenon of a screen upon driving the plasma display apparatus and a driving method thereof.

According to an aspect of the present invention, there is provided a plasma display apparatus comprising: a waveform generator generating a setup waveform depending on an average picture level; and a plasma display panel to which the setup waveform is applied, wherein the number of the setup waveform set in a reference section in which the average picture level increases is different from the number of the setup waveform set in the same section in which the average picture level decreases.

According to another aspect of the present invention, there is provided a plasma display apparatus comprising a waveform generator generating a setup waveform depending on an average picture level; and a plasma display panel to which the setup waveform is applied, wherein a voltage of the setup waveform set in a reference section in which the average picture level increases is different from the voltage of the setup waveform set in the same section in which the average picture level decreases.

According to still another aspect of the present invention, there is provided a driving method of a plasma display apparatus which adjusts a driving waveform depending on frame data inputted from the outside, the method comprising: allowing the number of the setup waveform set in a reference section in which the average picture level increases to be different from the number of the setup waveform set in the same section in which the average picture level decreases.

According to the present invention, it is possible to improve image quality by preventing a flicker phenomenon of a screen.

### BRIEF DESCRIPTION OF THE DRAWINGS

The invention will be described in detail with reference to the following drawings in which like numerals refer to like elements.

FIG. 1 is a diagram illustrating a method of embodying a waveform of a high contrast ratio by changing the number of setup waveforms of a reset period according to a conventional APL step;

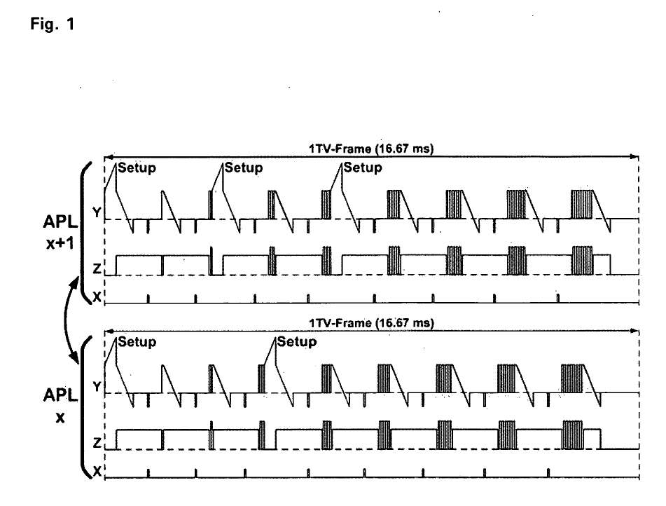

FIG. 2 is a diagram illustrating another method of embodying a waveform of a high contrast ratio by changing the number of setup waveforms of a reset period according to a conventional APL step;

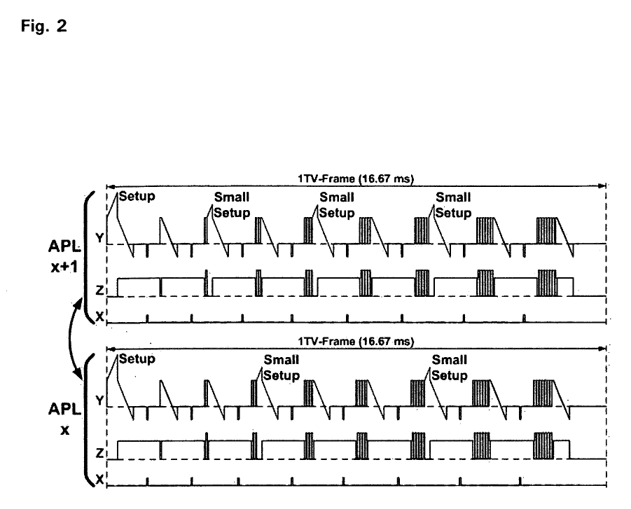

FIG. 3 is a diagram illustrating a method of applying to a plasma display apparatus by changing the number of setup waveforms or the number of setup waveforms having a low peak voltage according to the conventional APL step;

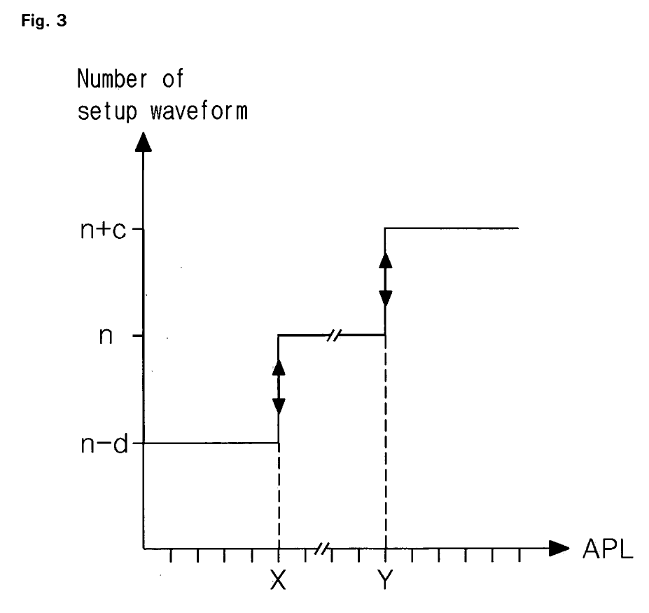

FIG. 4 is a diagram schematically illustrating a plasma display apparatus according to the present invention;

FIG. 5 is a diagram illustrating a driving method of a plasma display apparatus according to a first embodiment of the present invention;

FIG. 6 is a diagram illustrating another driving method of the plasma display apparatus according to the first embodiment of the present invention;

FIG. 7 is a diagram illustrating a driving method of a plasma display apparatus according to a second embodiment of the present invention;

FIG. 8 is a diagram illustrating another driving method of the plasma display apparatus according to the second embodiment of the present invention;

FIG. 9 is a diagram illustrating a driving method of a plasma display apparatus according to a third embodiment of the present invention; and

FIG. 10 is a diagram illustrating another driving method of the plasma display apparatus according to the third embodiment of the present invention.

### DETAILED DESCRIPTION OF PREFERRED EMBODIMENTS

Preferred embodiments of the present invention will be described in a more detailed manner with reference to the drawings.

According to an aspect of the present invention, there is provided a plasma display apparatus comprising: an APL controller controlling an average picture level (APL) to adjust the number of setup waveforms depending on frame data inputted from the outside; a waveform generator generating a setup waveform depending on the average picture level; and a plasma display panel to which the setup waveform is applied, wherein the number of the setup waveform set in a reference section in which the average picture level increases is different the number of the setup waveform set in the same section in which the average picture level decreases.

The number of the setup waveform set in the reference section in which the average picture level decreases may be larger than the number of the setup waveform set in the same section in which the average picture level increases.

A reference section within the average picture level may be plural.

The number of the setup waveform set in the reference section in which the average picture level increases may gradually increase.

The number of the setup waveform set in the reference section in which the average picture level decreases may gradually decrease.

The number of the setup waveform set in the reference section in which the average picture level increases may gradually increase; and the number of the setup waveform set in the reference section in which the average picture level decreases may gradually decrease.

When the average picture levels are equal, the number of the setup waveforms may be not equal.

According to another aspect of the present invention, there is provided a plasma display apparatus comprising: an APL controller controlling an average picture level (APL) to adjust a voltage of a setup waveform depending on frame data inputted from the outside; a waveform generator generating a setup waveform depending on the average picture level; and a plasma display panel to which the setup waveform is applied, wherein a voltage of the setup waveform set in a reference section in which the average picture level increases is different from the voltage of the setup waveform set in the same section in which the average picture level decreases.

According to still another aspect of the present invention, there is provided a driving method of a plasma display apparatus which adjusts a driving waveform depending on frame data inputted from the outside, the method comprising: allowing the number of the setup waveform set in a reference section in which the average picture level increases to be different from the number of the setup waveform set in the same section in which the average picture level decreases.

Hereinafter, a plasma display apparatus and a driving method thereof according to the present invention will be described in detail with reference to the accompanying drawings.

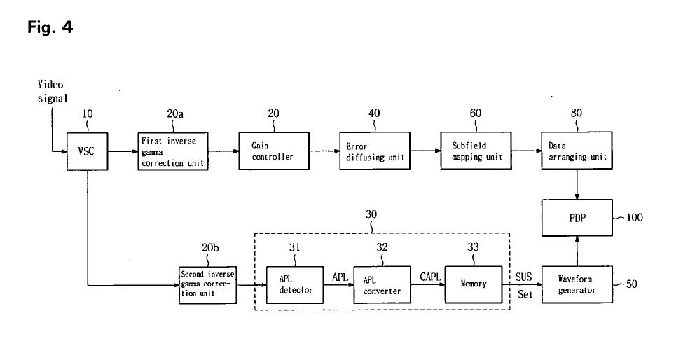

FIG. 4 is a diagram schematically illustrating a plasma display apparatus according to the present invention.

As shown in FIG. 4, a plasma display apparatus according to the present invention comprises a video signal control circuit (hereinafter, referred to as “VSC”) 10 for inputting a video signal, inverse gamma correction units 20A and 20B, a gain controller 20, an error diffusing unit 40, a subfield mapping unit 60, and a data arranging unit 80 connected between the VSC 10 and a plasma display panel 100 (hereinafter, referred to as “PDP”), a waveform generator 50 for supplying a timing control signal for generating sustain pulses to the PDP 100, and an APL controller 30 connected between the VSC 10 and the waveform generator 50.

The VSC 10 samples and digitalizes an analog video signal depending on a clock signal.

The inverse gamma correction units 20A and 20B comprises a first inverse gamma correction unit 20A and a second inverse gamma correction unit 20B and each inverse gamma correction unit inverse-gamma corrects a digital video signal from the VSC 10 and converts a brightness value based on a gray level value of a video signal to a lineal value.

The APL controller 30 comprises an APL detector 31, an APL converter 32, and a memory 33.

First, the APL detector 31 detects average brightness, i.e., an APL in a frame unit from data inputted from the second inverse gamma correction unit 20B. If it is assumed that input video data are 8 bits, the APL detected from the APL detector 31 is divided into 256 steps of 0 to 255 depending on a brightness value and if it is assumed that input video data are 16 bits, it is divided into 1024 steps from 0 to 1023 depending on a brightness value.

When an APL reference step detected by the APL detector 31 is the same as that of a previous frame (Fn−1), the APL converter 32 corrects the APL step and supplies the result (CAPL) to a look up table (hereinafter, referred to as “LUT”) of the memory.

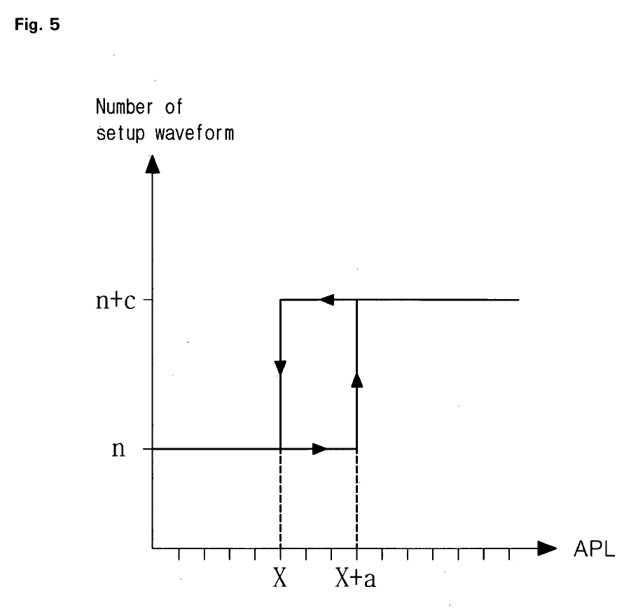

The memory 33 stores the APL detection result detected from the previous frame (Fn−1). The memory 33 compares the previous frame (Fn−1) and a current frame (Fn) continuously inputted from the APL detector 31 and outputs a value registered in the LUT depending on the compared result. It is preferable that the memory 33 is an erasable and programmable ROM (EPROM) for facilitating renewal of the LUT. A value registered in the LUT is the number information of the setup waveform and the number of sustain pulses (Set) depending on the APL reference step. The memory 33 and the APL converter 32 will be described with reference to FIGS. 5 to 10.

The gain controller 20 amplifies video data corrected in the first inverse gamma correction unit 20A by an effective gain.

The error diffusing unit 40 minutely adjusts a brightness value by diffusing error components to adjacent cells in data from the gain controller 20. For this reason, the error diffusing unit 40 divides data into an integer portion and a decimal portion and diffuses error components to adjacent cells by multiplying a floy-steinberg coefficient to the decimal portion.

The subfield mapping unit 60 maps data inputted from the error diffusing unit 40 to previously stored subfields and supplies the data to the data arranging unit 80 for each subfield.

The data arranging unit 80 supplies video data inputted from the subfield mapping unit 60 to a data driving integrated circuit (hereinafter, referred to as “IC”) of the PDP 100. The data driving IC is connected to data electrodes of the PDP 100 and latches data inputted from the data arranging unit 80 by one horizontal line and then supplies the latched data in one horizontal period unit to data electrodes.

The waveform generator 50 generates a timing control signal in response to information (SUS) of the number of the sustain pulses which is inputted from the memory 33 of the APL controller 30 and supplies the timing control signal to a data driving IC, a scan driving IC, and a sustain driving IC. The scan driving IC is connected to scan electrodes of the PDP 100 intersecting the data electrode and thus sequentially supplies scan pulses to the scan electrodes in response to a timing control signal inputted from the waveform generator 50, and then simultaneously supplies the sustain pulses to the scan electrodes during a sustain period. The sustain driving IC is parallel to the scan electrodes and supplies sustain pulses to the sustain electrodes formed in the PDP 100 to form a pair with the scan electrode.

FIG. 5 is a diagram illustrating a driving method of a plasma display apparatus according to a first embodiment of the present invention.

As shown in FIG. 5, in a driving method of the plasma display apparatus according to the first embodiment of the present invention, the APL reference section in which the number of the setup waveforms changes is adjusted depending on increase and decrease of APL steps when the number of the setup waveforms is controlled depending on the average picture level (APL) of inputted image data.

That is, the number of the setup waveforms set in a reference section in which the average picture level increases is set to be different from that of the setup waveforms set in the same section in which the average picture level decreases. Here, the APL reference section comprises a plurality of APL steps. For example, although an APL reference section of image data of a current frame (Fn) is the same as that of image data of a previous frame (Fn−1) using a APL converter 32 shown in FIG. 4, the APL reference section is set to be different from each other in a time point in which the number of setup waveforms increases or decreases if the change of APL step is set within the APL reference section and it is stored to the memory 33.

Specifically, if it is assumed that the number of the setup waveforms applied in an X step of a specific APL is n and an APL step higher than the X step is X+a step, the n+c number of setup waveforms larger by c than the number n of the setup waveforms applied in the X step are applied in the X+a step. Here, if an APL step of a previous frame (Fn−1) is an X step and an APL step of a current frame (Fn) is an X+a step, a time point in which the number of the setup waveforms increases increases in the X+a step of the APL. Otherwise, if the APL step of the previous frame (Fn−1) is the X+a step and the APL step of the current frame (Fn) is the X step, a time point in which the number of the setup waveforms decreases in the X step of the APL.

Time points in which the number of setup waveforms increases or decreases is from n to n+c are based on different steps of the APL. Therefore, although a predetermined image is repeated and the number of the setup waveforms uniformly changes, a flicker phenomenon generated when the same APL step is applied is not generated.

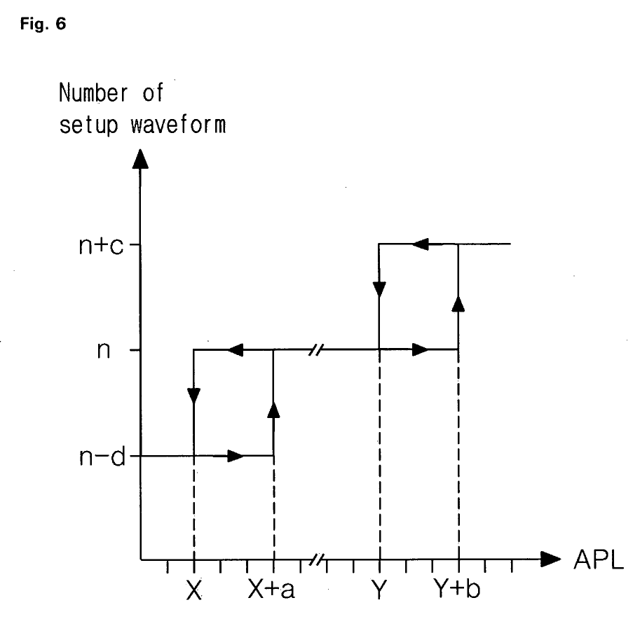

FIG. 6 is a diagram illustrating another driving method of the plasma display apparatus according to the first embodiment of the present invention. As shown in FIG. 6, another driving method of the plasma display apparatus according to the first embodiment of the present invention adjusts the APL reference section in which the number of the setup waveforms changes depending on an increasing direction or a decreasing direction of the APL step as in FIG. 5 and at this time, the APL reference section is set to plural.

Specifically, a flicker phenomenon can be prevented by applying different APL steps to the number of setup waveforms changing between X step and X+a step of the APL and the number of setup waveforms changing between Y step and Y+b step of the APL, where X, Y, n, a, b, c, and d are natural numbers comprising 0 and satisfy a relationship of X<Y and n>d.

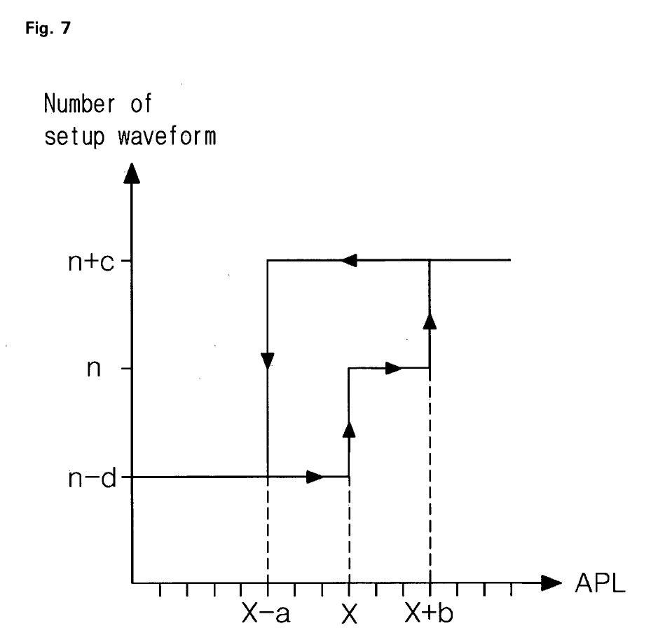

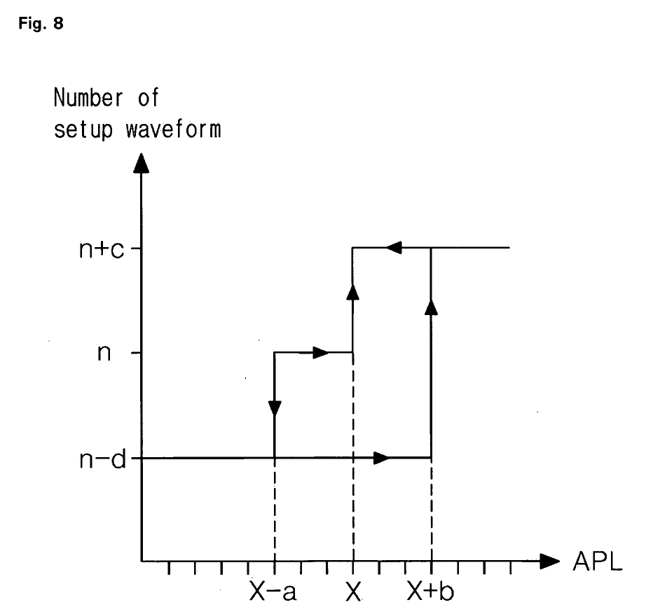

FIG. 7 is a diagram illustrating a driving method of a plasma display apparatus according to a second embodiment of the present invention and FIG. 8 is a diagram illustrating another driving method of a plasma display apparatus according to the second embodiment of the present invention.

First, referring to FIG. 7, the driving method of a plasma display apparatus according to the second embodiment of the present invention gradually increases the number of setup waveforms by setting the APL reference section to plural when image data abruptly changes in the APL reference section, for example, when image data abruptly increases in the APL reference section.

Specifically, in the driving method of the plasma display apparatus according to the second embodiment of the present invention, if the number of setup waveforms in X−a step of a specific APL is n−d, the number of setup waveforms in X+b step higher than the X−a step is n+c and the number of setup waveforms in the X step that is an approximately central step of the X−a step and the X+b step is n, where X, a, b, c, and d are natural numbers comprising 0 and satisfy a relationship of n>d and X−a>X>X+b.

At this time, if an APL step of a previous frame (Fn−1) is the X−a step and an APL step of a current frame (Fn) is the X+b step, the number of setup waveforms in the X step of the APL firstly increases from n−d to n and that of setup waveforms in the X+b step of the APL secondly increase from n-d to n+c. Otherwise, if the APL step of the previous frame (Fn-1) is the X+b step and the APL step of the current frame (Fn) is the X−a step, the number of setup waveforms in the X−a step of the APL decreases from n+c to n−d.

Each time point in which the increasing number of the setup waveforms changes from n−d to n+c through n and the decreasing number of the setup waveforms changes from n+c to n−d is based on each different step of the APL. Therefore, even in a case where the number of the setup waveforms uniformly changes because a predetermined image is repeated, it is possible to prevent a flicker phenomenon.

Similarly, as shown in FIG. 8, in another driving method of the plasma display apparatus according to the second embodiment of the present invention, if image data abruptly decreases in the APL reference section, the number of the setup waveforms gradually decreases by setting the APL reference section to plural and if image data increases, an effect shown in FIG. 7 is achieved by setting the APL reference section to single.

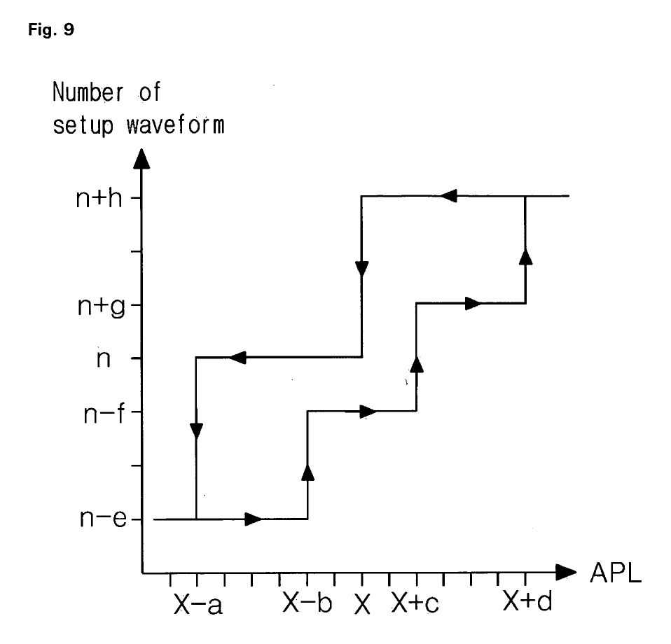

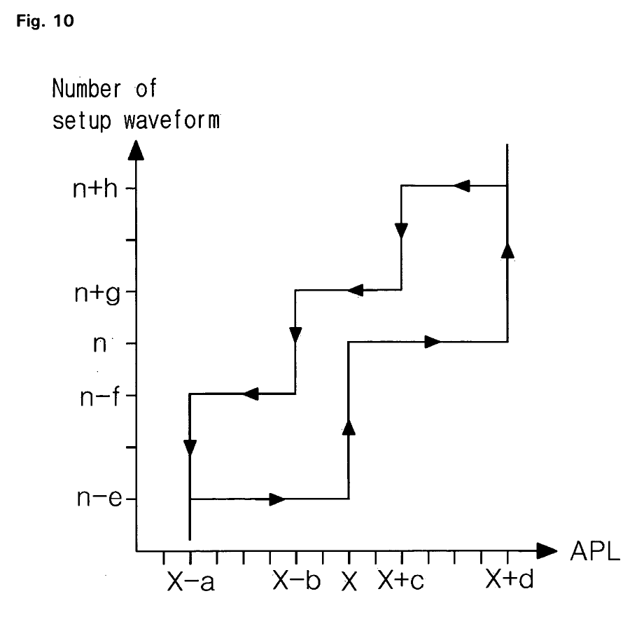

FIG. 9 is a diagram illustrating a driving method of a plasma display apparatus according to a third embodiment of the present invention and FIG. 10 is a diagram illustrating another driving method of the plasma display apparatus according to the third embodiment of the present invention.

First, referring to FIG. 9, in the driving method of a plasma display apparatus according to the third embodiment of the present invention, when image data abruptly change in the APL reference section, for example, when image data abruptly increases and abruptly decreases in the APL reference section, the number of the setup waveforms is gradually adjusted by setting the APL reference section to plural.

Specifically, in the driving method of a plasma display apparatus according to the third embodiment of the present invention, if the number of the setup waveforms in the X step of a specific APL is n, the number of the setup waveforms in X+c step that is a higher step than the X step is n+g, the number of the setup waveforms in X+d step that is a higher step than the X+c step is n+h, the number of the setup waveforms in an X−b step that is a lower step than the X step is n−f, and the number of the setup waveforms in the X−a step that is a lower step than the X−b step is n−e, where X, a, b, c, d, e, f, g, and h are natural numbers comprising 0 and satisfy a relationship of n−e>0, X−a<X−b<X<X−c<X−d, and n−e<n−f<n<n+g<n+h.

At this time, if the APL step of the previous frame (Fn−1) is the X−a step and the APL step of the current frame (Fn) is X+d step, the number of the setup waveforms in the X−b step of the APL firstly increases from n−e to n−f, the number of the setup waveforms in the X+c step of the APL secondly increases from n−e to n+g, and the number of the setup waveforms in the X+d step of the APL finally increases from n−e to n+h. Otherwise, if the APL step of the previous frame (Fn−1) is the X+d step and the APL step of the current frame (Fn) is X−a step, the number of the setup waveforms in the X step of the APL firstly decreases from n+h to n, the number of the setup waveforms in the X−a step of the APL secondly decreases from n+h to n−e. Each time point in which the increasing number of the setup waveforms sequentially changes from n−e to n−f, n+g, and n+h and the decreasing number of the setup waveforms changes from n+h to n-e is based on each different step of the APL. Therefore, even in a case where the number of the setup waveforms uniformly changes because a predetermined image is repeated, it is possible to prevent a flicker phenomenon.

Similarly, as shown in FIG. 10, in another driving method of the plasma display apparatus according to the third embodiment of the present invention, if image data abruptly decrease in the APL reference section, the number of the setup waveforms gradually decreases by setting the APL reference section to n and if image data increase, an effect shown in FIG. 9 can be similarly achieved by setting the APL reference section to n−1.

Therefore, in the driving method of the plasma display apparatus according to each embodiment of the present invention, when the number of the setup waveforms (discharge is generated even in an off cell) applied during one frame changes depending on data change of an image signal displayed on a screen, the method sets so that there is a difference of the singular number or the plural number of APL step (a) between an APL step (X+a) in which the number of the setup waveforms increases (n−>n+c) by the singular number or the plural number from a specific number (n) and an APL step (X) in which the number of the setup waveforms decreases (n+c−>n) by the singular number or the plural number from a specific number (n), where x, a, n, and c are integers and satisfy a relationship of 0<X<the number of the APL steps, 0<a≦(the number of the APL steps)/2, 0≦n≦the number of subfields, and 0≦c≦the number of subfields.

On the other hand, in each embodiment of the present invention, a time point in which the APL step is applied divided into a frame unit, but this can be applied to portions in which the APL step changes depending on each condition, for example, various conditions in which a plurality of subfields is composed of a block unit or a space of a panel embodying an image is composed of a block unit. In addition, setup waveforms applied in each embodiment of the present invention can be formed with a setup waveform in which a peak voltage is constant and a setup waveform in which a peak voltage are different.

The invention being thus described, it will be obvious that the same may be varied in many ways. Such variations are not to be regarded as a departure from the spirit and scope of the invention, and all such modifications as would be obvious to one skilled in the art are intended to be comprised within the scope of the following claims.

What is claimed is:

1. A plasma display apparatus comprising:
a waveform generator generating a setup waveform depending on an average picture level; and
a plasma display panel to which the setup waveform is applied,
wherein the number of the setup waveform set in a reference section in which the average picture level increases is different from the number of the setup waveform set in the same section in which the average picture level decreases.

2. The plasma display apparatus of claim 1, wherein the number of the setup waveform set in the reference section in which the average picture level decreases is larger than the number of the setup waveform set in the same section in which the average picture level increases.

3. The plasma display apparatus of claim 1, wherein a reference section within the average picture level is plural.

4. The plasma display apparatus of claim 1, wherein the number of the setup waveform set in the reference section in which the average picture level increases gradually increases.

5. The plasma display apparatus of claim 1, wherein the number of the setup waveform set in the reference section in which the average picture level decreases gradually decreases.

6. The plasma display apparatus of claim 1, wherein the number of the setup waveform set in the reference section in which the average picture level increases gradually increases; and
the number of the setup waveform set in the reference section in which the average picture level decreases gradually decreases.

7. The plasma display apparatus of claim 6, wherein when the average picture levels are equal, the number of the setup waveforms are not equal.

8. A plasma display apparatus comprising:
a waveform generator generating a setup waveform depending on an average picture level; and
a plasma display panel to which the setup waveform is applied,
wherein a voltage of the setup waveform set in a reference section in which the average picture level increases is different from the voltage of the setup waveform set in the same section in which the average picture level decreases.

9. A method of driving a plasma display apparatus which adjusts a driving waveform depending on frame data inputted from the outside, the method comprising:
allowing the number of the setup waveform set in a reference section in which the average picture level increases to be different from the number of the setup waveform set in the same section in which the average picture level decreases.

10. The driving method of claim 9,
wherein the number of the setup waveform set in the reference section in which the average picture level decreases is larger than that of the setup waveform set in the same section in which the average picture level increases.

11. The driving method of claim 9,
wherein a reference section within the average picture level is plural.

12. The driving method of claim 9,
wherein the number of the setup waveform set in the reference section in which the average picture level increases gradually increases.

13. The driving method of claim 9,
wherein the number of the setup waveform set in a reference section in which the average picture level decreases gradually decreases.

14. The driving method of claim 9,
wherein the number of the setup waveform set in the reference section in which the average picture level increases gradually increases; and
the number of the setup waveform set in the reference section in which the average picture level decreases gradually decreases.

15. The driving method of claim 14,
wherein when the average picture levels are equal, the number of the setup waveforms are not equal.
